(19) United States
(12) Patent Application Publication
(10) Pub. No.: US 2011/0227271 A1
(43) Pub. Date: Sep. 22, 2011

(54) HEIGHT-ADJUSTABLE OUT-FEED TABLE FOR TABLE SAW

(76) Inventor: Norman D. Edelmann, Nelson (CA)

(21) Appl. No.: 13/130,955

(22) PCT Filed: Dec. 9, 2009
(86) PCT No.: PCT/CA09/01792

§ 371 Date: May 24, 2011

Related U.S. Application Data
(60) Provisional application No. 61/120,916, filed on Dec. 9, 2008.

(51) Int. Cl. B23Q 3/00

(52) U.S. Cl. 269/289 R

(57) ABSTRACT

A portable out-feed support table has a planar main out-feed support surface which is adjustable for both height and plane. Optional extension leaves, hinged to the edges of the main support, facilitate expansion of the length and surface area of the table, and preferably have foldable, length-adjustable support legs. In its fully-expanded configuration, the out-feed table allows a table saw operator to cut through large or lengthy workpieces with the out-feed material being at all times supported at substantially the same height and in the same plane as the saw table. In its most compact configuration, with the main out-feed support in its lowermost position and with the extension leaves folded down, the out-feed table can be manually carried by a worker, and is readily stowable in a vehicle. The out-feed table can also be configured for use with mitre gauges or saw sleds which require travel beyond the saw table, but at a height below the table saw surface.

### FIELD OF INVENTION

The present invention relates in general to portable apparatus for supporting workpieces and other materials. The invention relates in particular to portable apparatus for supporting workpieces that have passed through a table saw.

### BACKGROUND OF THE INVENTION

It is common in the construction trade to use table saws for cutting pieces of material that are considerably longer than the length of the table saw surface. Common examples of such materials are sheet materials such as plywood, fiberboard, and plastic laminate, as well as elongate pieces of lumber that need to be run lengthwise through the table saw to meet particular construction project requirements. It is typically desirable or necessary to provide support for the portions of material that have exited the table saw (referred to herein as “out-feed” material), to ensure that portions of the workpiece yet to pass through the saw will be in generally planar contact with the table saw surface, rather than being temporarily deformed due to gravity-induced bending of out-feed material extending beyond the table saw surface. This is important to ensure that the workpiece passes smoothly through the rotating saw blade; otherwise, the workpiece can bind on the saw blade, and/or pieces of the workpiece can be cast off by the rotating blade at considerable velocity, thus creating a safety hazard. Lack of out-feed support also commonly results in localized splintering of the workpiece as it completes its pass through the saw blade.

It is desirable, from standpoints of both safety and work quality, to use out-feed support means that will allow the table saw operator's full attention to be focussed on directing the workpiece through the saw blade, rather than on supporting the workpiece at the same time. One way to provide out-feed support is for the saw operator to have a helper who will support and guide the out-feed material until the entire workpiece has exited the saw blade. However, that is often not a practical or economic option, so saw operators commonly need to use some type of temporary out-feed support apparatus. Improvised temporary out-feed supports are typically unsatisfactory, for reasons such as potentially hazardous instability, and difficulty in providing support at a proper height and plane corresponding to the table saw surface.

Commercially-available material support devices are typically only a few inches in width, thus necessitating the use of multiple such support devices to provide adequate support for long workpieces. This creates another problem, however, as the saw operator's attention must be partially diverted to the out-feed material as it approaches each support device, to ensure that it passes over the support rather than butting into it. In addition to these types of problems, both improvised and commercial types of material supports are particularly difficult to set up satisfactorily in common situations (such as construction sites) where the ground surface is of uneven elevation and/or irregular in texture.

U.S. Pat. No. 6,298,946 (Yemini et al.) discloses a sawhorse having a workpiece support element that is adjustable for both height and width. However, the support element is essentially linear and thus provides only a small surface area. Accordingly, two or more of the Yemini sawhorses would need to be used to support lengthy out-feed material from a table saw. As well, the legs of the Yemini device are of fixed length, which would make it difficult to use the device as an effective table saw out-feed support on uneven or irregular surfaces.

The prior art discloses numerous other examples of adjustable sawhorses and adjustable work supports, including U.S. Pat. Nos. 6,209,683 (Holtz); 6,283,250 (Asher); 6,401,865 (Elwick); 6,422,343 (Berg et al.); 6,488,119 (DuRapau et al.); 6,564,903 (Krajec); 6,601,675 (Gulledge); 6,712,180 (Levy); 6,817,445 (Slemmer); 6,827,181 (Austin et al.); 7,021,424 (Herman); 7,111,708 (Frey); 7,168,666 (Tucker); 7,172,053 (Slavich); 7,185,738 (Clepper); and 7,320,383 (Plate). However, none of these prior art devices satisfactorily addresses the issues and problems identified above.

### BRIEF SUMMARY OF INVENTION

To address the foregoing practical problems, the present invention provides a portable out-feed support table having a height-adjustable, main out-feed support member with a planar upper surface, which in preferred embodiments can also be adjusted to match the plane of the working surface of an adjacently-positioned table saw (or other apparatus). Also in preferred embodiments, one or preferably two planar extension leaves, each having a planar upper surface, are hingeingly attached to opposite edges of the main out-feed support member, thereby facilitating a substantial expansion of the total length and planar area available for material support as project requirements may warrant. Due to the ease with which it may be adjusted for height, plane, and size of support surface, the out-feed support table allows a saw operator's focus to be on the workpiece passing through the saw blade.

In its fully-expanded configuration, the out-feed table allows a table saw operator to cut through a large workpiece such as an eight-foot long sheet of plywood, with the out-feed material being at all times supported at substantially the same height and in the same plane as the working surface of the table saw. The extension leaves can be folded down along the sides of the base structure of the out-feed table, to facilitate use of the out-feed table with smaller workpieces while taking up minimal floor space. In its most compact configuration, with the main out-feed support member in its lowermost position and with the extension leaves folded down, the out-feed table can be conveniently carried by a worker from one place to another on a construction site, or readily stowed in a vehicle. The out-feed table can also be configured to allow the operator to use mitre gauges or saw sleds which require travel beyond the saw table, but at a height below the top surface.

### BRIEF DESCRIPTION OF THE DRAWINGS

Embodiments of the invention will now be described with reference to the accompanying figures, in which numerical references denote like parts, and in which:

FIG. 1 is a perspective view of an out-feed table in accordance with one embodiment of the present invention, shown in a fully-expanded configuration, with the main out-feed support member in a raised position.

FIG. 2 is a perspective view of an out-feed table as in FIG. 1, but with the first extension leaf in a folded position.

FIG. 3 is a perspective view of an out-feed table as in FIG. 1, shown in a partially-collapsed configuration.

FIG. 4 is a side view of a fully-expanded out-feed table as in FIG. 1, with the main out-feed support member in a raised position

FIG. 5 is a side view of an out-feed table as in FIG. 4, showing the outrigger legs of the secondary extension in a collapsed configuration and being folded against the underside of the first extension leaf.

FIG. 6 is a side view of an out-feed table as in FIG. 5, showing main out-feed support member in its lowermost position, and with the first extension being folded against the base structure of the out-feed table.

FIG. 7 is a side view of an out-feed table as in FIG. 6, but with both the first and second extension leaves folded against the base structure.

FIG. 8 is a side view of an out-feed table configured as in FIG. 7, but with the base structure in a collapsed configuration.

FIG. 9 is an exploded isometric view of components of a first embodiment of a vertical locking mechanism for use in conjunction with an out-feed table in accordance with the present invention.

FIG. 10 is a vertical cross-section through an out-feed table as in FIG. 1, incorporating a vertical locking mechanism as in FIG. 9, shown in the unlocked position.

FIG. 10a is a sectional detail through the cross-beams and vertical support structure of the embodiment shown in FIG. 10.

FIG. 11 is a vertical cross-section similar to FIG. 10, but with the vertical locking mechanism, shown in the locked position.

FIG. 12 is a vertical cross-section through an out-feed table as in FIG. 1, incorporating a second embodiment of a vertical locking mechanism.

FIG. 13 is plan view of a vertical locking mechanism as in FIG. 12.

FIG. 14 is an end view of a vertical locking mechanism as in FIG. 12.

### DETAILED DESCRIPTION OF PREFERRED EMBODIMENT

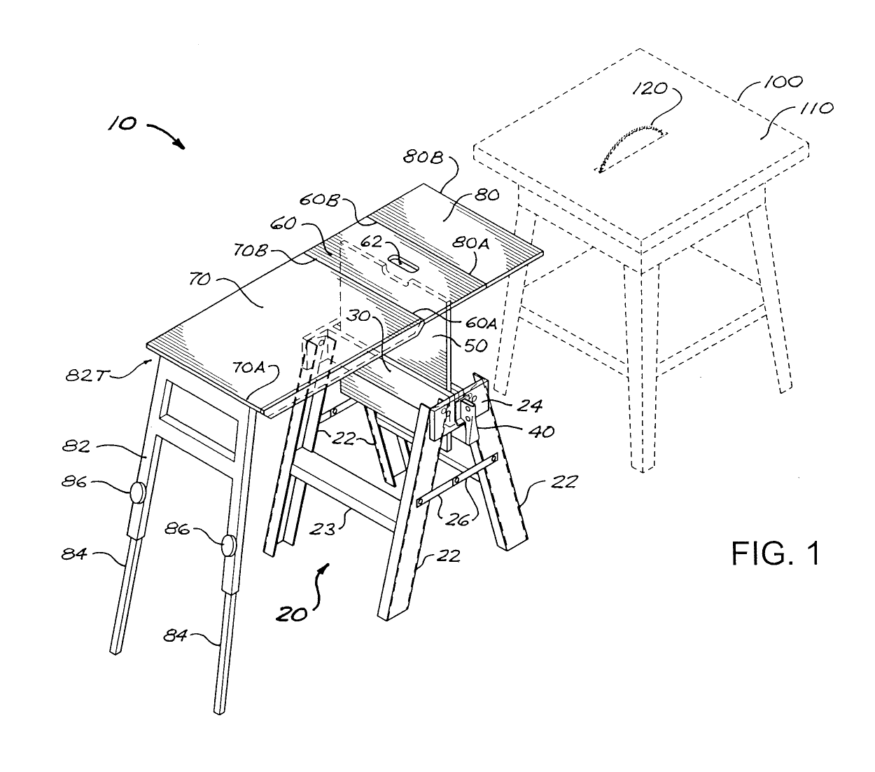

FIG. 1 illustrates a material out-feed table 10 in accordance with a first embodiment of the present invention, shown positioned adjacent to a table saw 100 having a saw table surface 110 and a circular saw blade 120. Out-feed table 10 comprises a base structure 20 having a transverse support structure 30 adapted to receive a height-adjustable vertical support structure 50, with a locking mechanism for releasably locking vertical support structure 50 in a selected vertical position. A main out-feed support member 60, having a planar upper surface, is connected to and rigidly supported by vertical support structure 50 such that the upper surface of main out-feed support member 60 is perpendicular to vertical support structure 50. By adjusting the vertical position of vertical support structure 50. relative to support assembly 30, the vertical height of main out-feed support member 60 can be readily set to the same elevation as saw table surface 110, thereby providing effective support for a workpiece exiting from table saw 100 after passing through saw blade 120.

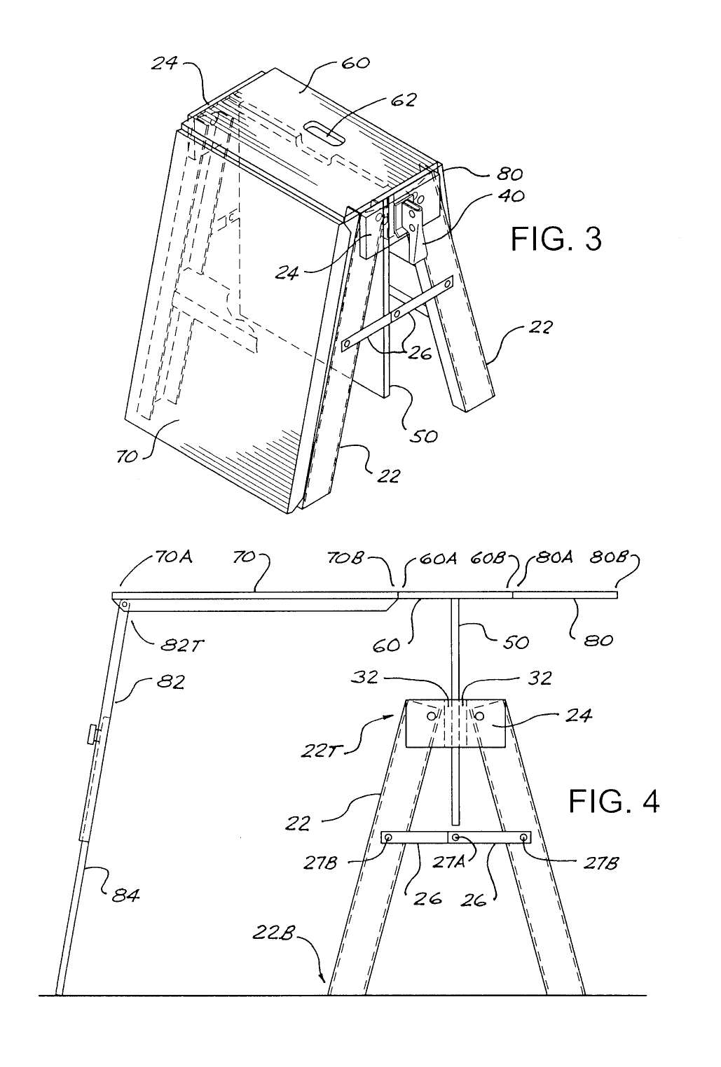

Height-adjustable main out-feed support member 60 will be sufficient to provide effective support for out-feed material in many practical applications. In preferred embodiments, however, out-feed table 10 also has at least one extension leaf for expanding the total length (in the direction of workpiece movement through saw blade 120) and area available for support of out-feed material from table saw 100. Accordingly, in the embodiment shown in the Figures, out-feed table 10 also has a first extension leaf 70 having a planar upper surface, a first transverse edge 70A, and an opposing second transverse edge 70B. First extension leaf 70 is hinge-mounted along its second edge 70B to main out-feed support member 60 along a first transverse edge 60A thereof, such that first extension leaf 70 can be oriented horizontally, at the same level as main out-feed support member 60, or rotated to a generally vertical orientation alongside base structure 20 as shown in FIG. 3.

Similarly, and as shown in FIGS. 1-8, out-feed table 10 may also have a second extension leaf 80 having a planar upper surface, first transverse edge 80A, and opposing second transverse edge 80B, hinge-mounted along its first edge 80A to main out-feed support member 60 along a second transverse edge 60B thereof, such that second extension leaf 80 can be oriented horizontally, at the same level as main out-feed support member 60, or rotated to a generally vertical orientation alongside base structure 20.

The extending length L₇₀ or L₈₀ of either or both of first and second extension leaves 70 and 80 may be relatively short (like second extension leaf 80 as shown in FIG. 1), such that it can extend horizontally away from main out-feed support member 60 without need for particularly robust means for releasably holding it in the horizontal position. For example, in simple embodiments of out-feed table 10, either or both of first and second extension leaves 70 and 80 could be maintained in the horizontal position using means as simple as an elongate horizontally-pivoting support member mounted on the underside of main out-feed support member 60 (analogous to pivoting supports commonly used with drop-leaf tables). However, the present invention is not limited or restricted to this particular construction. Persons of ordinary skill will readily appreciate that there are many means by which extension leaves 70 and 80 can be hinged to main out-feed support member 60 and temporarily supported in co-planar relationship therewith.

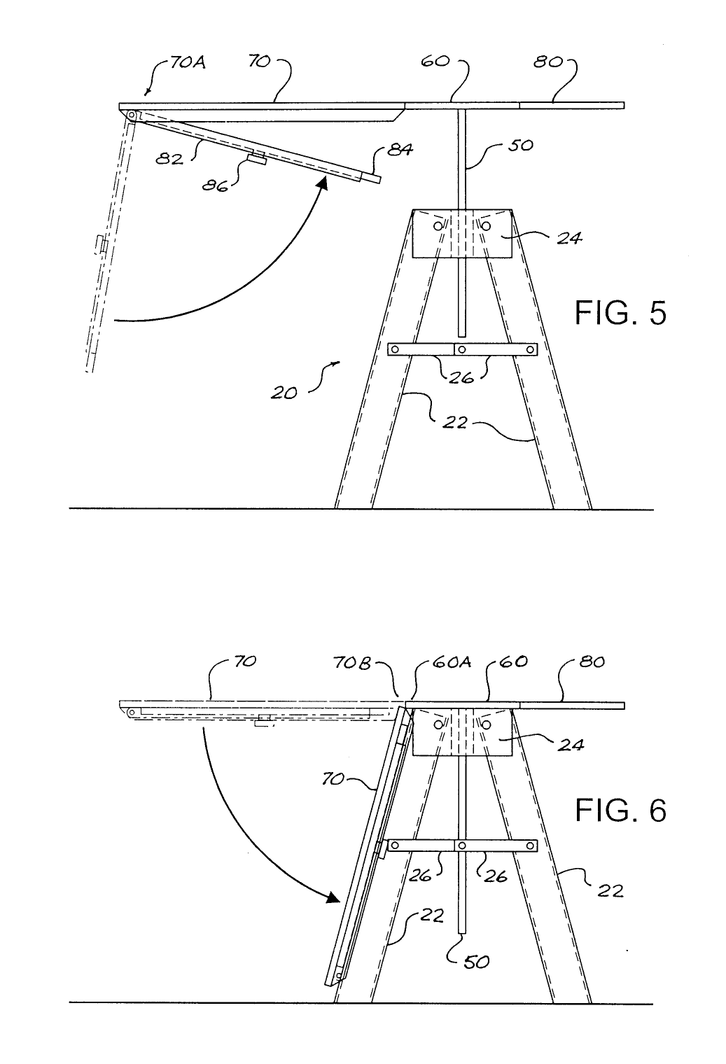

However, it will commonly be desirable for out-feed table 10 to have at least one fairly lengthy extension leaf to facilitate support of lengthy workpieces exiting table saw 100, and in such cases more substantial means will typically be required to support the extension leaf under the weight of out-feed material passing over it. Accordingly, and as shown in FIG. 1, first extension leaf 70 in certain embodiments of out-feed table 10 will have an extending length L₇₀ close to the vertical height of base structure 20, so as to maximize length L₇₀ while still allowing first extension leaf 70 to be folded down alongside base structure 20 when not needed. One or more auxiliary support legs 72, the top end or ends 72T of which are hingeingly connected to first extension leaf 70 proximal to first edge 70A thereof, such that auxiliary support legs 72 can be rotated upward and stowed against the underside of first extension leaf 70 as illustrated in FIG. 5, thereby allowing first extension leaf 70 to be rotated downward alongside base structure 20 as shown in FIG. 6.

Auxiliary support legs 82 are adjustable in length to accommodate different heights at which main out-feed support member 60 may be adjusted to matching different heights of saw table surface 110. As shown in FIGS. 1, 2, and 4, this feature may be provided by way of telescoping extension legs 84 associated with auxiliary support legs 82, with suitable means (conceptually indicated by reference numeral 86) for releasably locking extension legs in desired positions relative to auxiliary support legs 82. Preferably, extension legs 84 will be independently telescoping to facilitate use on irregular surfaces.

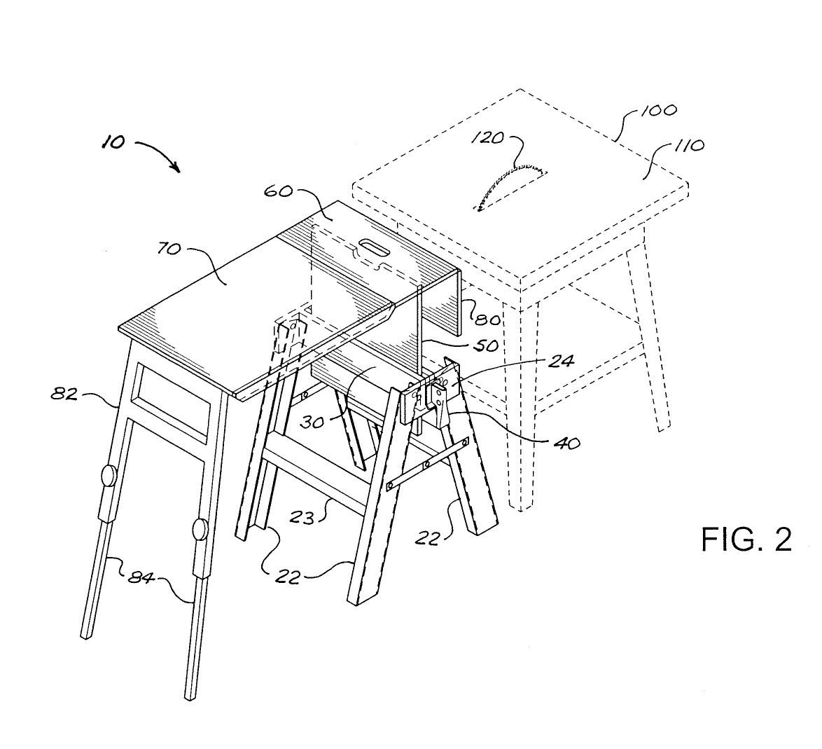

Base structure 20 is not restricted to any particular form, but will preferably be collapsible or foldable for ease of transportation and storage. In the embodiment shown in the Figures, base structure 20 is provided in the general form of a collapsible sawhorse, with two pairs of base legs 22 each having a top end 22T and a bottom end 22B, and with top ends 22T of each pair of base legs 22 being pivotably connected to a common end bracket 24. As best seen in FIGS. 1 and 2, one or more optional strut members 23 may extend between corresponding base legs 22 of the two pairs of base legs 22 to provide base structure 20 with increased strength and stability. A pair of hinged tie members 26 preferably extends between medial regions of each pair of base legs 22, with first ends of each pair of tie members 26 being pivotably connected to each other by a middle pivot pin 27A, and with each other end of each tie member 26 being pivotably connected to one of the base legs 22 by an outer pivot pin 27B. Tie members 26 thus limit the extent to which base legs 22 can be splayed, but allow base legs 22 to be folded against each other as shown in FIG. 8 (much like similar tie members commonly used for conventional stepladders).

Transverse support structure 30, which extends between and is rigidly connected to first and second end brackets 24A and 24B at each end of base structure 20, also is not restricted to any particular structural configuration. Transverse support structure 30 is configured to receive vertical support structure 50 in association with locking means for releasably locking vertical support structure 50 in a selected vertical position to suit specific project requirements (such as but not necessarily limited to matching the height of main out-feed support member 60 to the height of a saw table surface 110).

In the illustrated embodiment, vertical support structure 50 is a flat-sided, vertically-oriented panel having first and second vertical side edges 50A and 50B, and a top end 50T securely connected to a medial region of the underside of main out-feed support member 60. Vertical support structure 50 and main out-feed support member 60 may be provided as separate pieces, and then connected using suitable adhesives, fasteners, and/or bracing elements as appropriate to provide a sufficiently rigid interconnection. Alternatively, vertical support structure 50 and main out-feed support member 60 could be of unitary construction, in the form of a moulded or extruded plastic component.

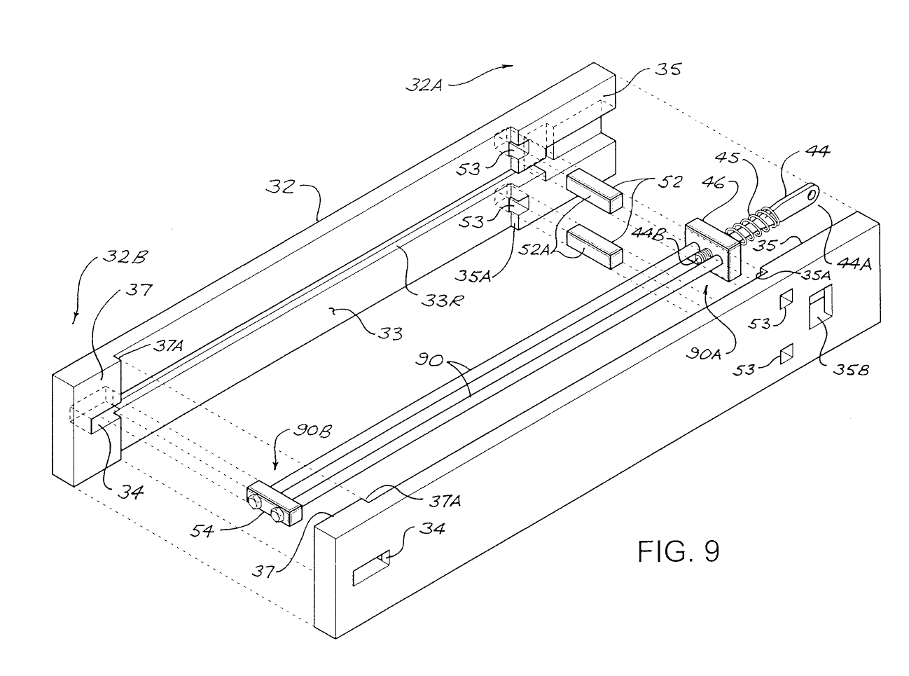

FIGS. 9, 10, and 11 illustrate one embodiment of a locking mechanism for use with a vertical support structure 50 of panel-type configuration as shown in FIGS. 1-8. For purposes of this embodiment, transverse support structure 30 comprises a pair of cross-beams 32 extending between end brackets 24, and having parallel juxtaposed vertical inner faces 33 spaced to receive vertical support structure 50 in vertically slidable fashion as shown. First and second flat shoulder sections 35 and 37 are formed at first and second ends 32A and 32B of each cross-beam 32, with the flat shoulders being proud of but substantially parallel to the corresponding vertical inner faces, such that in the assembled transverse support structure 30, the first and second flat shoulders 35 and 37 of each cross-beam 32 will abut or be closely adjacent to the corresponding first and second flat shoulders 35 and 37 of the other cross-beam 32, leaving a horizontally elongate gap between vertical faces 33 to receive vertical support structure 50. Each first shoulder 35 has a vertical inner edge face 35A, and each second shoulder 37 has a vertical inner edge face 37A, with the distance between vertical inner edge face 35A and vertical inner edge face 37A corresponding to the width of the panel-type vertical support structure 50 (i.e., the horizontal distance between side edges 50A and 50B thereof) plus minimal clearance. In the assembled transverse support structure 30, the two vertical inner edge faces 35A will be in substantially co-planar alignment with each other, as will the two vertical inner edge faces 37A, thereby effectively forming vertical guides for side edges 50A and 50B of vertical support structure 50, such that main out-feed support member 60 will remain substantially bi-directionally horizontal throughout its range of vertical travel.

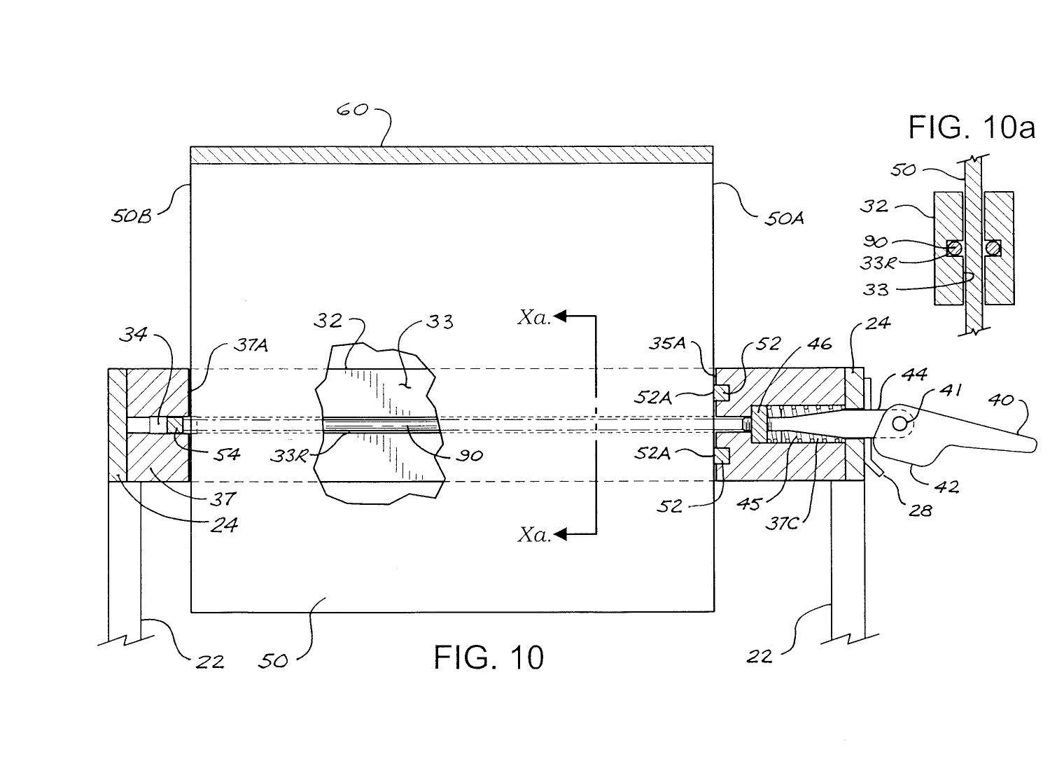

In this embodiment, the locking mechanism comprises a pair of laterally-spaced elongate tension rods 90 each having a first end 90A and a second end 90B. First ends 90A of tension rods 90 engage a first anchor block 46, and second ends 90B of tension rods 90 engage a second anchor block 54, such that tension rods 90 are substantially parallel on opposite sides of vertical support structure 50, and preferably (but not necessarily) disposed within corresponding horizontal rod grooves 33R formed into inner vertical faces 33 of cross-beams 32, as shown in FIG. 10a. The ends of first anchor block 46 are disposed within corresponding horizontal slots 37B in first shoulders 35, so as to allow horizontal movement of first anchor block 46 relative to cross-beams 32. The ends of second anchor block 54 are disposed within horizontal slots in cross-beams 32 proximal to second shoulders 37, so as to allow horizontal movement of second anchor block 54 relative to cross-beams 32. A pair of vertically spaced bearing bars 52, each having a bearing face 52A, extend transversely between anchorage openings 53 formed in cross-beams 32 proximal to first shoulders 35, above and below rod horizontal slots 37B and grooves 33R, with bearing faces 52A oriented vertically and being adjacent to but projecting slightly beyond vertical inner edge faces 35A, such that they can come into contact with first side edge 50A of vertical support structure 50. Bearing faces 52A will preferably have knurling or other surface texturing for enhanced gripping engagement with first side edge 50A. Similarly, second anchor block 54 may optionally be provided with surface texturing for enhanced gripping engagement with second side edge 50B.

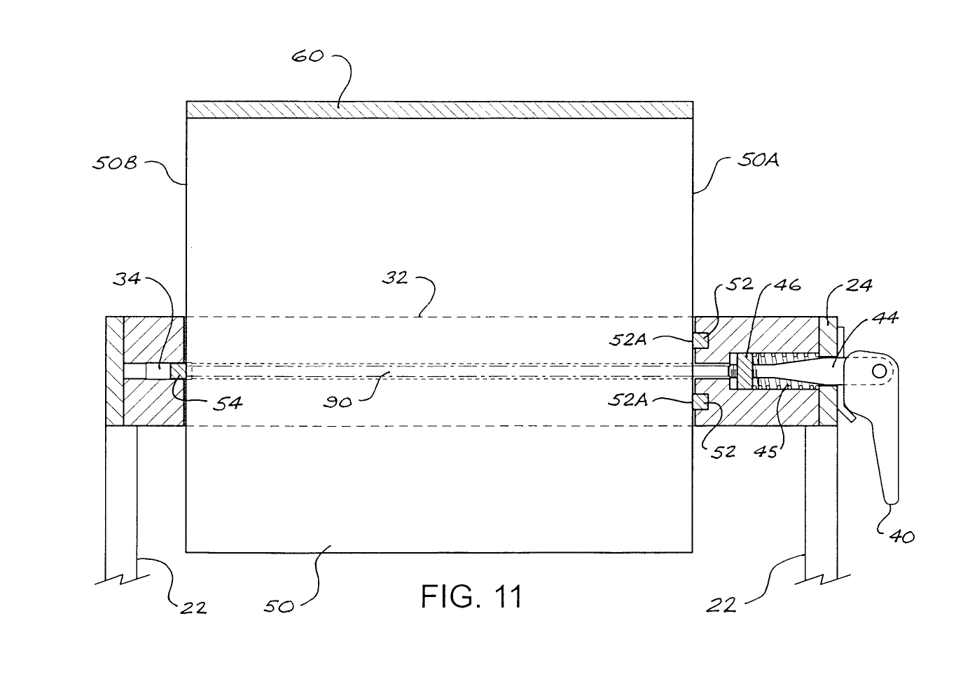

The locking mechanism further comprises a locking lever 40 which is rotatably connected to an outer end 44A of a tension member 44 by means of a suitable bolt or pivot pin 41. The inner end 44B of tension member 44 extends through a channel formed by horizontal grooves 37C in first shoulders 35, and connects to first anchor block 46 at a medial point between tension rods 90 (preferably by means of a threaded connection as conceptually shown in FIGS. 9, 10, and 11, to facilitate adjustment of the locking mechanism). Locking lever 40 is formed with a camming surface 42 such that when the locking lever is in an unlocked position as illustrated in FIG. 10, rotation of locking lever 40 will cause camming surface 42 to engage the outer face of first end bracket 24A (which is preferably with a wear plate 28 as shown in FIGS. 10 and 11). This action results in outward horizontal movement of tension member 44, and corresponding horizontal movement of first anchor block 46, second anchor block 54, and tension rods 90. This causes vertical support structure 50 to be effectively clamped between bearing bars 52 pressing against first side edge 50A of vertical support structure 50, and second anchor block 54 pressing against second side edge 50B of vertical support structure 50, as shown in FIG. 11. When it is desired to change the vertical position of vertical support structure 50, locking lever 40 is rotated to restore the locking mechanism to the unlocked position shown in FIG. 10. Optionally, biasing means such as a helical spring 45 may be provided in association with tension member 44 to facilitate return to the unlocked position.

In variants of the assembly described immediately above, bearing bars 52 could be omitted, such that when the locking mechanism is actuated, first side edge 50A of vertical support structure 50 will bear against vertical inner edge faces 35A of first shoulders 35. Persons skilled in the art will also appreciate that the configuration of second anchor block 54 could be different from that shown in the Figures, without departing from the scope and functional concept of the invention. For example, second anchor block 54 could have a greater vertical thickness, or could have auxiliary vertical elements, for increasing the size of the contact surface between second anchor block 54 and second side edge 50B of vertical support structure 50.

As best appreciated from FIG. 9, first and second shoulder sections 35 and 37 may be formed integrally with cross-beams 32, with each cross-beam 32 being in the form of a unitary plastic moulding, or being milled from a solid piece of wood. Alternatively, first and second shoulders 35 and 37 could be provided as separate pieces that are glued or otherwise connected to cross-beams 32.

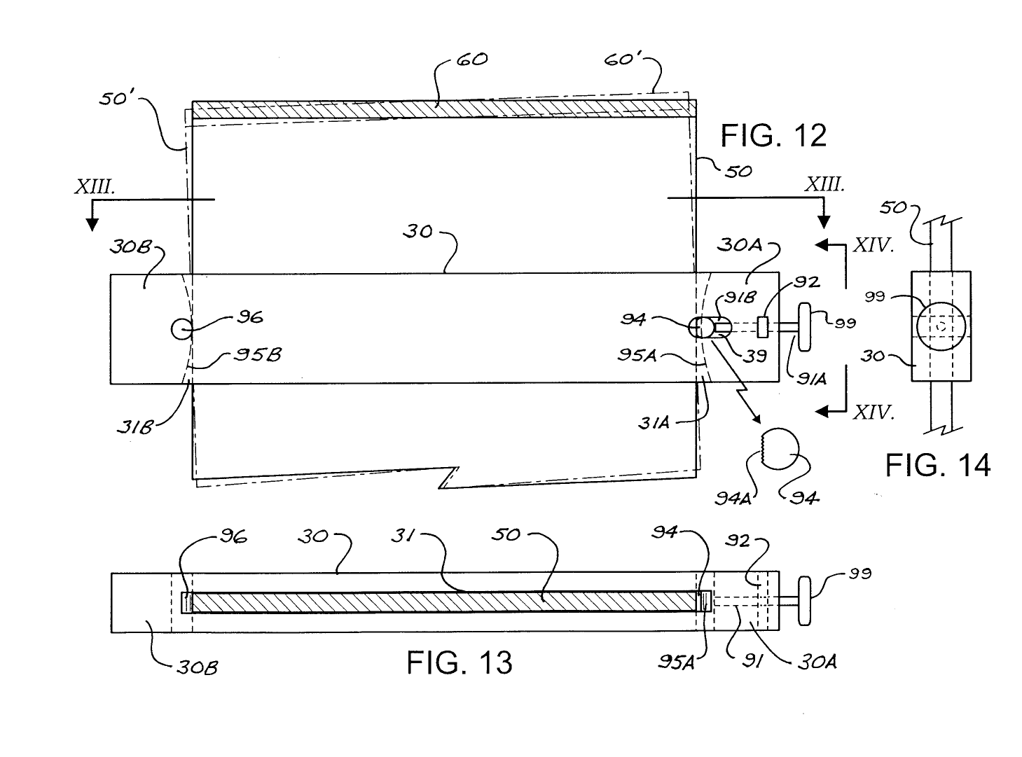

FIGS. 12-14 illustrate an alternative locking mechanism for use with a vertical support structure 50 of panel-type configuration as shown in FIGS. 1-8. In this embodiment, transverse support structure 30 defines a horizontally-elongate gap 31 (as best seen in FIG. 13) for receiving vertical support structure 50. In the illustrated embodiment, transverse support structure 30 is formed with first and second convexly curved end walls 95A and 95B at first and second ends 31A and 31B of gap 31 (corresponding to first and second end portions 30A and 30B of transverse support structure 30). The purpose of the convex curvature in end walls 95A and 95B is to facilitate a certain amount of transverse angular adjustment of vertical support structure 50, as will be explained.

As shown in FIG. 12, a first (and horizontally movable) bearing bar 94 is provided with its ends disposed with a horizontal slot 39 in first end portion 30A of transverse support structure 30, proximal to first end 31A of gap 31, and a second (and stationary) bearing bar 96 is anchored in second end portion 30B of transverse support structure 30, proximal to second end 31B of gap 31. The locking mechanism further comprises a crank or other type of rotatable handle 99 connected to an outer end 91A of a locking screw 91, the inner end 91B of which extends horizontally into first end portion 30A of transverse support structure 30, so as to be engageable with first bearing bar 94. A medial portion of locking screw 91 is threaded, and passes through a correspondingly threaded nut member 92 incorporated into first end portion 30A, as schematically depicted in FIGS. 12 and 13. Accordingly, rotation of handle 99 in a first direction will cause inner end 91B of locking screw 91 to move first bearing bar 94 horizontally toward gap 31. This action will cause vertical support structure 50 to be effectively clamped between first bearing bar 94 pressing against first side edge 50A of vertical support structure 50, and second bearing bar 96 pressing against second side edge 50B of vertical support structure 50, as may be understood from FIG. 12.

The provision of curved first and second end walls 95A and 95B within gap 31 makes it possible to clamp vertical support structure 50 and main support member 60 in a tilted position (as illustrated in broken outlines 50′ and 60′ in FIG. 12), thereby facilitating adjustment of the plane of main support member 60 to suit uneven surfaces upon which out-feed table 10 may be supported. To enhance clamping effectiveness, the regions of first and second bearing bars 94 and 96 will preferably be provided with surface texturing for enhanced gripping engagement with first and second side edges 50A and 50B of vertical support structure 50 (such as, for example, a flattened and serrated contact surface 94A on first bearing bar 94, as shown in the inset detail of FIG. 12).

In FIG. 13, base structure 20 is not shown, but would of course be provided to support the ends of transverse support structure 30. Transverse support structure 30 is shown in FIG. 13 as being of unitary construction, but it could alternatively comprise a pair of suitably configured parallel cross-beams joined together. In variants of the locking mechanism shown in FIG. 13, second bearing bar 96 could be omitted, and second curved end wall 95B could be provided with grip-enhancing surface texturing for direct engagement with second side edge 50B of vertical support structure 50.

In a third (and unillustrated) alternative embodiment, the locking mechanism for use with a vertical support structure 50 of panel-type configuration is a hybrid of the mechanism shown in FIGS. 9-14. In this embodiment, the locking mechanism comprises a pair of tension rods 90 shown in FIG. 9, with first and second ends 90A and 90B. First ends 90A of tension rods 90 are immovably anchored to first shoulders 35 of cross-beams 32. Second ends are of rods 90 are connected to a second anchor block 54 as shown in FIG. 9, but in this embodiment second anchor block 54 is immovably anchored to second shoulders 37 of cross-beams 32. A “floating” bearing bar has two spaced holes through which rods 90 pass through, such that the floating bearing bar is slidable along rods 90. When the panel-type vertical support structure 50 is positioned in the assembly, the floating bearing bar is in juxtaposition with first end face 50A of vertical support structure 50. The actuation mechanism in this embodiment is generally similar to the locking screw and handle arrangement shown in FIGS. 12-14, with rotation of the handle 99 causing inner end 91B of locking screw 91 to move the floating bearing bar horizontally along rods 90 toward first end face 50A of vertical support structure 50. This action will cause vertical support structure 50 to be effectively clamped between the floating bearing bar pressing against first side edge 50A of vertical support structure 50, and second bearing bar 96 pressing against second side edge 50B.

In the out-feed table as described and illustrated herein, the vertical support structure 50 is provided in the form of a flat-sided panel member. However, the invention is not restricted to a vertical support structure 50 of this or any other particular configuration, and persons skilled in the art will appreciate that vertical support structure 50 could be provided in a variety of other configurations without departing from the scope of the present invention.

To provide one non-limiting alternative example, vertical support structure 50 could comprise two or more elongate vertical members, the upper ends of which support main out-feed support member 60. These elongate vertical members could be tubular members or solid bars of any suitable cross-sectional shapes, and for convenience will be referred to herein as support rods. The support rods would be receivable by the transverse support structure 30 such that they are vertically movable, either independently or in concert, relative to transverse support structure 30, with suitable means provided for releasably locking the support rods at desired heights. In such embodiments, the locking means for a given support rod could be a simple collar mounted to or incorporated into transverse support structure 30, with an associated set screw or other conventional clamping means for releasably locking the support rod in a selected vertical position relative to the collar.

A first (unillustrated) variant of this concept features two support rods rigidly connected at their upper ends to main out-feed support member 60, such that both support rods always move together. Optionally, the upper ends of the support rods could be connected to main out-feed support member 60 with horizontal pivot axes perpendicular to transverse support structure 30, thereby allowing for independent vertical movement of the support rods and facilitating adjustment of the plane of main out-feed support member 60 in one direction. In a further variant, the out-feed table could have three or more vertical support rods, each of which has a two-directionally pivotable connection (for example, a ball-and-socket joint), thereby facilitating adjustment of the plane of main out-feed support member 60 in two directions.

In yet another variant, vertical support structure 50 could comprise a single vertically-adjustable support member (for example, a round or rectangular tubular member) having sufficient structural strength and stiffness to cantilever vertically upward from a corresponding sleeve built into transverse support structure. Main out-feed support member 60 could be rigidly connected to the upper end of such single vertical support member, or it could be pivotably connected to the main support member to facilitate adjustment of the plane of main out-feed support member 60 in one or two directions.

As illustrated in FIGS. 3-8, out-feed table 10 can be configured in variety of ways to suit specific project requirements and worksite conditions. Out-feed table 10 can be configured with main out-feed support member 60 either lowered or set at a selected height, with either or both of first and second extension leaves 70 and 80 in their raised positions to expand the available support surface area, or folded out of the way against the sides of base structure 20. The tilt or plane of main out-feed support member 60 (and, in turn, the plane of extension leaves 70 and 80, when deployed) can be adjusted to match an adjacently-positioned table saw 100 to facilitate use on uneven ground surfaces (or to accommodate other project conditions or requirements). In a fully-expanded configuration as shown in FIGS. 1 and 4, out-feed table 10 provides maximal support surface area for use in spacious work areas, while being collapsible to provide a smaller support surface and a minimal “footprint” for use in restricted work areas. As shown in FIG. 8, out-feed table 10 can be fully collapsed for transport and storage. For ease of carrying in the collapsed configuration, a handhold opening 62 may be provided in main out-feed support member 60 as shown in FIGS. 1-3.

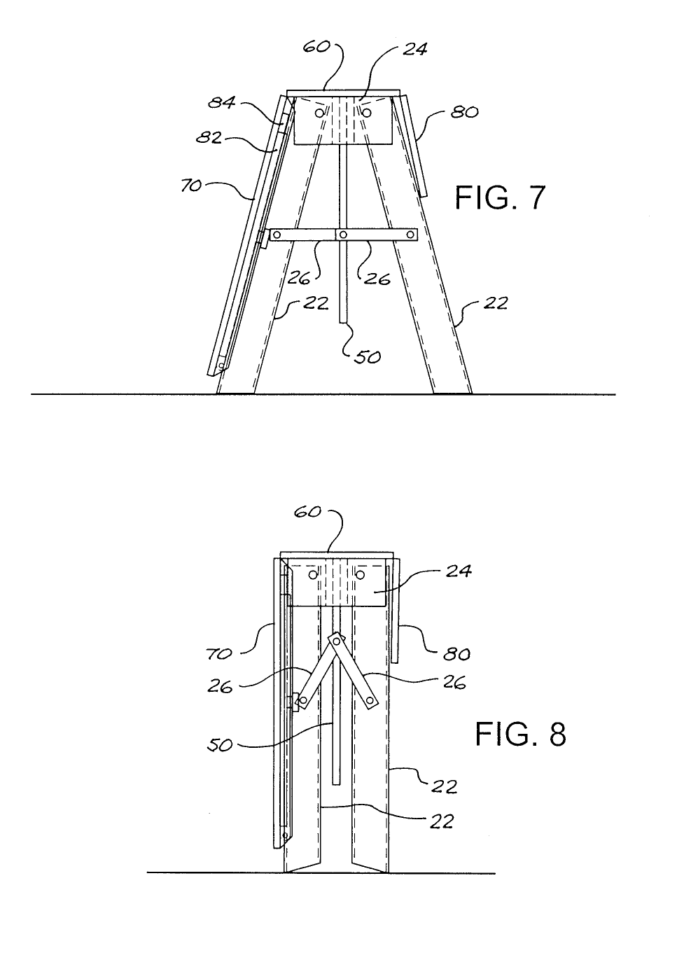

When configured as shown in FIGS. 3 and 7, with main out-feed support member 60 and both extension leaves lowered, but with base legs 22 splayed to stabilize base structure 20, out-feed table 10 can serve as a small step ladder, with one or more strut members 23 serving as steps on a side of base structure 20 not having an extension leaf or having a comparatively narrow extension leaf.

The out-feed table of the present invention has been described and illustrated in the context of its use in association with a table saw, to support cut materials exiting the saw. However, persons skilled in the art will immediately understand that it is not limited to particular use. Although it has been referred to herein as an “out-feed table”, it is readily usable or adaptable as a portable support apparatus for many other practical purposes in the construction trades and other fields.

It will be readily appreciated by those skilled in the art that various modifications of the present invention may be devised without departing from the scope and teaching of the present invention, including modifications which may use equivalent structures or materials hereafter conceived or developed. It is to be especially understood that the invention is not intended to be limited to any described or illustrated embodiment, and that the substitution of a variant of a claimed element or feature, without any substantial resultant change in the working of the invention, will not constitute a departure from the scope of the invention. It is also to be appreciated that the different teachings of the embodiments described and discussed herein may be employed separately or in any suitable combination to produce desired results.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element. Any use of any form of the terms “connect”, “engage”, “couple”, “attach”, or any other term describing an interaction between elements is not meant to limit the interaction to direct interaction between the subject elements, and may also include indirect interaction between the elements such as through secondary or intermediary structure. Relational terms such as “parallel”, “perpendicular”, horizontal”, “vertical”, “coplanar”, “coincident”, “intersecting”, and “equidistant” are not intended to denote or require absolute mathematical or geometrical precision. Accordingly, such terms are to be understood as denoting or requiring substantial precision only (e.g., “substantially parallel”) unless the context clearly requires otherwise. The terms “vertical” and “horizontal” are to be interpreted assuming that the working surface of the main out-feed support member of the present invention is in a horizontal orientation (notwithstanding that other orientations are conceivably possible depending on how the out-feed table is used in particular applications).

The embodiments of the invention in which an exclusive property or privilege is claimed are defined as follows:

1. A portable support apparatus comprising:
(a) a base structure having a transverse support structure;
(b) a vertical support structure having a top end, and being mounted to the transverse support structure so as to be vertically movable relative thereto;
(c) a main support member mounted to the top end of the vertical support structure, said main support member having a planar upper surface opposing first and second transverse edges; and
(d) locking means, for releasably locking the vertical support structure in a selected vertical position relative to the transverse support structure.

2. A portable support apparatus as in claim 1, further comprising a first extension leaf having a planar upper surface opposing first and second transverse edges, said first extension leaf being hingeingly mounted, along its second transverse edge, to the main support member along the main support member's first transverse edge, such that the first extension leaf can be moved between a lowered position and a raised position, in which raised position the upper surface of the first extension leaf is coplanar with the upper surface of the main support member.

3. A portable support apparatus as in claim 1 or claim 2, further comprising a second extension leaf having a planar upper surface opposing first and second transverse edges, said second extension leaf being hingeingly mounted, along its first transverse edge, to the main support member along the main support member's second transverse edge, such that the second extension leaf can be moved between a lowered position and a raised position, in which raised position the upper surface of the second extension leaf is coplanar with the upper surface of the main support member.

4. A portable support apparatus as in claim 2 or claim 3, further comprising one or more auxiliary support legs hingeingly connected to the first extension leaf proximal to the first transverse edge thereof.

5. A portable support apparatus as in claim 4 wherein at least one of the auxiliary support legs comprises a telescoping extension leg.

6. A portable support apparatus as in any of claims 1 to 5 wherein the vertical support structure comprises a flat-sided, vertically-oriented panel having first and second vertical side edges, and wherein:
(a) the transverse support structure has a first end and a second end and comprises first and second cross-beams, each said cross-beam having first end and a second end, a vertical inner face, and first and second flat shoulders formed at said first and second ends of the cross-beam, respectively, each said first and second flat shoulder being proud of and parallel to said vertical inner face;
(b) the first and second flat shoulders of each cross-beam have parallel juxtaposed vertical inner edge faces; and
(c) in the assembled transverse support structure, the first and second flat shoulders of the first cross-beam are in adjacent juxtaposition to the first and second flat shoulders of the second cross-beam respectively, thus forming a horizontally elongate gap separating the vertical inner faces of the cross-beams, and extending between the vertical inner edge faces of the first flat shoulders and the vertical inner edge faces of the second flat shoulders;
such that the vertically-oriented panel is disposable within, and vertically movable within, said horizontally elongate gap.

7. A portable support apparatus as in claim 6 wherein the locking means comprises:
(a) a pair of laterally-spaced elongate tension rods each having a first end and a second end, the first ends of said tension rods engaging a first anchor block, and the second ends of said tension rods engaging a second anchor block, wherein:
a.1 the ends of the first anchor block are disposed within horizontal slots in the first shoulders; and
a.2 the ends of the second anchor block are disposed within horizontal slots in the second shoulders;
(b) a pair of vertically spaced bearing bars, each having a vertical bearing face, extending between anchorages proximal to the first shoulders, above and below said horizontal slots in the first shoulders, with said vertical bearing faces adjacent to but clear of the vertical inner edge faces of the first shoulders;
(c) a horizontally-oriented tension member having an inner end and an outer end, said inner end of the tension member being connected to the first anchor block, and said outer end of the tension member projecting externally of the first end of the transverse support structure; and
(d) a locking lever pivotably connected to the outer end of the tension member, said locking lever having a camming surface;
and wherein:
(e) the vertically-oriented panel is disposed:
e.1 within the gap between the vertical inner faces of the cross-beams; and
e.2 between the tension rods; and
(f) the locking lever is rotatable between an unlocked position and a locked position, wherein rotation of the locking lever from the unlocked position to the locked position causes the camming surface to engage an external region of the transverse support structure so as to cause outward horizontal movement of the tension member, thereby drawing the second anchor block into contact with the second side edge of the vertically-oriented panel and urging the first side edge of the vertically-oriented panel into contact with the bearing faces of the bearing bars.

8. A portable support apparatus as in claim 7 wherein the bearing face of at least one of the bearing bars has grip-enhancing surface texturing.

9. A portable support apparatus as in claim 6 wherein the locking means comprises:
(a) a pair of laterally-spaced elongate tension rods each having a first end and a second end, the first ends of said tension rods engaging a first anchor block, and the second ends of said tension rods engaging a second anchor block, wherein:
a.1 the ends of the first anchor block are disposed within horizontal slots in the first shoulders; and
a.2 the ends of the second anchor block are disposed within horizontal slots in the second shoulders;
(b) a horizontally-oriented tension member having an inner end and an outer end, said inner end of the tension member being connected to the first anchor block, and said outer end of the tension member projecting externally of the first end of the transverse support structure; and
(c) a locking lever pivotably connected to the outer end of the tension member, said locking lever having a camming surface;
and wherein:
(d) the vertically-oriented panel is disposed:
d.1 within the gap between the vertical inner faces of the cross-beams; and
d.2 between the tension rods; and
(e) the locking lever is rotatable between an unlocked position and a locked position, wherein rotation of the locking lever from the unlocked position to the locked position causes the camming surface to engage an external region of the transverse support structure so as to cause outward horizontal movement of the tension member, thereby drawing the second anchor block into contact with the second side edge of the vertically-oriented panel and urging the first side edge of the vertically-oriented panel into contact with the vertical inner edge faces of the first flat shoulders.

10. A portable support apparatus as in any of claims 7 to 9 wherein the connection between inner end of the tension member and the first anchor block is a threaded connection.

11. A portable support apparatus as in any of claims 1 to 5 wherein the vertical support structure comprises a flat-sided, vertically-oriented panel having first and second vertical side edges, and wherein:
(a) the transverse support structure has a first end and a second end and comprises first and second cross-beams, each said cross-beam having first end and a second end, a vertical inner face, and first and second flat shoulders formed at said first and second ends of the cross-beam, respectively, each said first and second flat shoulder being proud of and parallel to said vertical inner face; and
(b) in the assembled transverse support structure, the first and second flat shoulders of the first cross-beam are in adjacent juxtaposition to the first and second flat shoulders of the second cross-beam respectively, thus forming a horizontally elongate gap separating the vertical inner faces of the cross-beams, such that the vertically-oriented panel is disposable within, and vertically movable within, said horizontally elongate gap.

12. A portable support apparatus as in claim 11 wherein the locking means comprises:
(a) a first bearing bar extending between horizontal slots in the cross-beams proximal to the first shoulders thereof;
(b) a second bearing bar extending between anchorages in the cross-beams proximal to the second shoulders thereof; and
(c) a horizontally-oriented, rotatable locking screw having an inner end and an outer end, said outer end projecting externally of the first end of the transverse support structure, and said locking member having a threaded section engageable with a matingly-threaded receiver in the first end of the transverse support structure;
such that rotation of the locking screw in a first direction will displace the inner end of the locking screw inward so as to urge the first bearing bar into contact with the first side edge of the vertically-oriented panel, and in turn urging the second side edge of the vertically-oriented panel into contact with the second bearing bar.

13. A portable support apparatus as in claim 12 wherein the inner end of the locking screw is rotatably retained by the first bearing bar.

14. A portable support apparatus as in claim 6 wherein the locking means comprises:
(a) a pair of laterally-spaced elongate tension rods each having a first end and a second end, the first ends of said tension rods engaging a first anchor block, and the second ends of said tension rods engaging a second anchor block, wherein:
a.1 the ends of the first anchor block are immovably anchored to the cross-beams proximal to the first shoulders thereof; and
a.2 the ends of the second anchor block are immovably anchored to the cross-beams proximal to the second shoulders thereof;
(b) a floating bearing bar slidingly mounted over the tension rods, with said tension rods passing through corresponding openings in the floating bearing bar; and
(c) a horizontally-oriented, rotatable locking screw having an inner end and an outer end, said outer end projecting externally of the first end of the transverse support structure, and said locking member having a threaded section engageable with a matingly-threaded receiver in the first end of the transverse support structure;
such that when the vertically-oriented panel is disposed between the tension rods and within the gap between the vertical inner faces of the cross-beams, rotation of the locking screw in a first direction will displace the inner end of the locking screw inward so as to urge the floating bearing bar into contact with the first side edge of the vertically-oriented panel, and in turn urging the second side edge of the vertically-oriented panel into contact with the second bearing bar.

15. A portable support apparatus as in any of claims 1 to 5 wherein the vertical support structure comprises a pair of spaced elongate vertical support bars.

16. A portable support apparatus as in claim 15 wherein:
(a) the support bars are independently vertically movable relative to the transverse support structure; and
(b) the connection between the upper end of each support bar and the main support member has a horizontal pivot axis perpendicular to the first transverse edge of the main support member.

17. A portable support apparatus as in any of claims 1 to 5 wherein the vertical support structure comprises three or more spaced elongate vertical support bars.

18. A portable support apparatus as in claim 17 wherein:
(a) the support bars are independently vertically movable relative to the transverse support structure; and
(b) the connection between the upper end of each support bar and the main support member is a two-directionally pivotable connection.

19. A portable support apparatus as in any of claims 1 to 5 wherein the vertical support structure comprises a single elongate vertical support bar.

20. A portable support apparatus as in claim 19 wherein the support bar is pivotably connected to the main support member.

21. A portable support apparatus as in any of claims 1 to 20 wherein the base structure is of collapsible construction.
